(19) United States
(12) Patent Application Publication
(10) Pub. No.: US 2026/0088891 A1
(43) Pub. Date: Mar. 26, 2026

(54) SYSTEMS AND METHODS FOR CONNECTING MARINE VESSELS TO A SATELLITE COMMUNICATIONS NETWORK

(71) Applicant: Space Exploration Technologies Corp., Hawthorne, CA (US)

(72) Inventors: Jeremy Engels, Bellevue, WA (US); Robert Wiggenhorn, Seattle, WA (US)

(21) Appl. No.: 19/338,574

(22) Filed: Sep. 24, 2025

Related U.S. Application Data
(60) Provisional application No. 63/699,661, filed on Sep. 26, 2024.

(51) Int. Cl. H04B 7/185; H01Q 1/12; H01Q 1/28; H01Q 1/34; H01Q 21/06

(52) U.S. Cl. CPC H04B 7/18513; H01Q 1/125; H01Q 21/06; H04B 7/18539; H01Q 1/288; H01Q 1/34

(57) ABSTRACT

A vessel gateway for a satellite communication system including a plurality of satellites can include a vessel gateway (VGW) antenna mounted on a pedestal and steerable according to pointing instructions expressed relative to a pedestal-based reference frame; an attitude user terminal including a phased array antenna affixed to the vessel and configured to output an orientation signal indicating an orientation of the phased array antenna with respect to an Earth-fixed reference frame; and a control processor configured to perform steps including one or more of: determining a vector, in the Earth-fixed reference frame, from a current position of the vessel to a first satellite of the satellites; generating, based on the orientation signal, adjusted pointing instructions expressed in the pedestal-based reference frame and configured to point the VGW antenna along the vector; and commanding the VGW antenna to apply the adjusted pointing instructions.

### TECHNICAL FIELD

The present technology pertains to network communication paths utilizing satellites and more specifically to connecting marine vessels to a satellite communications network.

### BACKGROUND

Satellite communication systems can provide Internet access to user terminals at user terminal locations, for example at homes or businesses. The satellite in this context can receive, from a user terminal, a request for data, such as a web page the user desires to view or a video a user desires to watch by way of non-limiting examples. The user will typically be at a user device which can be a computing device such as a computer or a mobile device. The user device gains access to the Internet via the user terminal and its connection to the satellite. The satellite in turn will transmit signals to a ground station (called a gateway terminal) on Earth with the request to obtain the data. The gateway terminal is connected to a point-of-presence (PoP) on the Internet or another ground-based network or data storage device that stores the requested data. The satellite and the gateway terminal transmit and receive signals via a respective satellite gateway-wavelength antenna and a gateway terminal antenna. The gateway terminal will access the Internet or other network to obtain the desired data and to transmit the data up to the satellite. The satellite then transmits the data down to the user terminal using a user terminal-wavelength antenna, such that the user can access the data on a user device.

One use case for satellite-based Internet access is for users aboard marine vessels, where traditional land-based Internet access points are not available. However, it may not be feasible or affordable to mount a sufficient number of user terminals to provide access to the satellite-based network for every prospective user aboard the vessel, particularly (but not only) in the case of ocean liners and cruise ships with tens, hundreds, or thousands of passengers. It would be beneficial to provide marine vessels with a high-throughput satellite-based link to the Internet that can accommodate such numbers of users.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

This disclosure provides a new approach to implementing a high-throughput link to the Internet for a vessel, such as a marine vessel, via a satellite communication system. Rather than relying on traditional user terminals of the satellite communication network, which are typically each sized and configured to handle Internet traffic for a limited number of users, the present disclosure provides a “vessel gateway,” that is, one or more dedicated high-throughput gateway terminal antennas mounted on the marine vessel.

The antenna of the vessel gateway can be connected to a vessel attitude monitoring system to maintain pointing accuracy towards the satellite as the marine vessel traverses the water. More specifically, the high-throughput antennas must be mechanically steered to track satellites in low-Earth orbit (LEO) as the satellites successively cross the sky over the antenna site. The tracking process can be complicated as the vessel, which provides the platform for the antennas of the vessel gateway, is not fixed with respect to the Earth, but rather may pitch and roll, for example as it moves on an open sea. In the present disclosure, correcting the pointing direction for the motion of the vessel relative to the Earth can be simplified by leveraging real-time orientation-sensing capabilities of one or more user terminals mounted on the vessel and in communication with the vessel attitude monitoring system.

In accordance with an embodiment of the present disclosure, a vessel gateway for a satellite communication system including a plurality of satellites is provided. The vessel gateway can include a pedestal affixed to a vessel; a vessel gateway (VGW) antenna mounted on the pedestal and steerable to track any one of the satellites according to pointing instructions expressed relative to a pedestal-based reference frame; an attitude user terminal (AUT) including an AUT phased array antenna affixed to the vessel and configured to output an orientation signal indicating an orientation of the AUT phased array antenna with respect to an Earth-fixed reference frame; and a control processor coupled in signal communication with the attitude user terminal and coupled to a memory storing instructions executable to cause the control processor to perform control processor steps of the method 700, which can include one or more of: determining a vector, in the Earth-fixed reference frame, from a current position of the vessel to a first satellite of the satellites; generating, based on the orientation signal, adjusted pointing instructions expressed in the pedestal-based reference frame and configured to point the VGW antenna along the vector; and commanding the VGW antenna to apply the adjusted pointing instructions.

In accordance with another embodiment of the present disclosure, a method of operating a vessel gateway for a satellite communication system is provided. The satellite communication system includes a plurality of satellites, wherein the vessel gateway includes a pedestal affixed to a vessel; a vessel gateway (VGW) antenna mounted on the pedestal and steerable to track any one of the satellites according to pointing instructions expressed relative to a pedestal-based reference frame; an attitude user terminal (AUT) including an AUT phased array antenna affixed to the vessel and configured to output an orientation signal indicating an orientation of the AUT phased array antenna with respect to an Earth-fixed reference frame; and a control processor coupled in signal communication with the attitude user terminal and configured to perform steps of the method, which can include one or more of: determining a vector, in the Earth-fixed reference frame, from a current position of the vessel to a first satellite of the satellites; generating, based on the orientation signal, adjusted pointing instructions expressed in the pedestal-based reference frame and configured to point the VGW antenna along the vector; and commanding the VGW antenna to apply the adjusted pointing instructions.

### BRIEF DESCRIPTION OF THE DRAWINGS

In order to describe the manner in which the above-recited issues can be addressed, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a simplified schematic of an exemplary satellite communication system, including a vessel gateway, in accordance with embodiments of the present disclosure;

FIG. 1B illustrates a simplified block diagram of the satellite communication system of FIG. 1A in accordance with embodiments of the present disclosure;

FIG. 2 is a schematic showing exemplary planar orbital patterns of a group of satellites, which may be used in the satellite communication system of FIG. 1A, around a rotating Earth in accordance with embodiments of the present disclosure;

FIG. 3 illustrates a not-to-scale aerial view of an exemplary ground area that may be serviced by the satellite communication system of FIG. 1A, including user terminals grouped into service cells, the vessel gateway, and gateway terminals;

FIG. 4 illustrates a not-to-scale aerial view of the ground area shown in FIG. 3 being serviced by certain exemplary satellites of the group in communication with the user terminals, the vessel gateway, and the gateway terminals;

FIG. 5 illustrates a simplified block diagram of example elements of the vessel gateway shown in FIG. 1A in combination with the satellite communication system shown in FIG. 1A, in accordance with embodiments of the present disclosure;

FIG. 6A illustrates a simplified schematic diagram of an example parabolic antenna that can be used to implement one of the gateway terminals or the vessel gateway, in an example pedestal-based reference frame, in accordance with embodiments of the present disclosure;

FIG. 6B illustrates a simplified schematic diagram of an example orientation, relative to an Earth-fixed reference frame, of the parabolic antenna of FIG. 6A mounted on a vessel and applying “uncorrected” pointing instructions developed for the pedestal-based reference frame, in accordance with embodiments of the present disclosure;

FIG. 6C illustrates a simplified schematic diagram of an example orientation of the parabolic antenna shown in FIG. 6A and an attitude user terminal mounted on the vessel, in accordance with embodiments of the present disclosure;

FIG. 6D illustrates a simplified schematic diagram of an example orientation, with respect to the Earth-fixed reference frame, of the attitude user terminal and the parabolic antenna of FIG. 6C mounted on the vessel, in accordance with embodiments of the present disclosure;

FIG. 6E illustrates a simplified schematic diagram of an example orientation, with respect to a user terminal (UT)-fixed reference frame, of a position signal received at a phased array antenna of the attitude user terminal of FIG. 6D, in accordance with embodiments of the present disclosure;

FIG. 6F illustrates a simplified schematic diagram of the parabolic antenna of FIG. 6C mounted on the vessel and applying adjusted pointing instructions, in accordance with embodiments of the present disclosure;

FIG. 7 illustrates an example method in accordance with embodiments of the present disclosure; and

FIG. 8 illustrates a computer system that can be implemented with other aspects of the present disclosure.

### DESCRIPTION OF EXAMPLE EMBODIMENTS

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment. Such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

### Elements of a Satellite Communication System

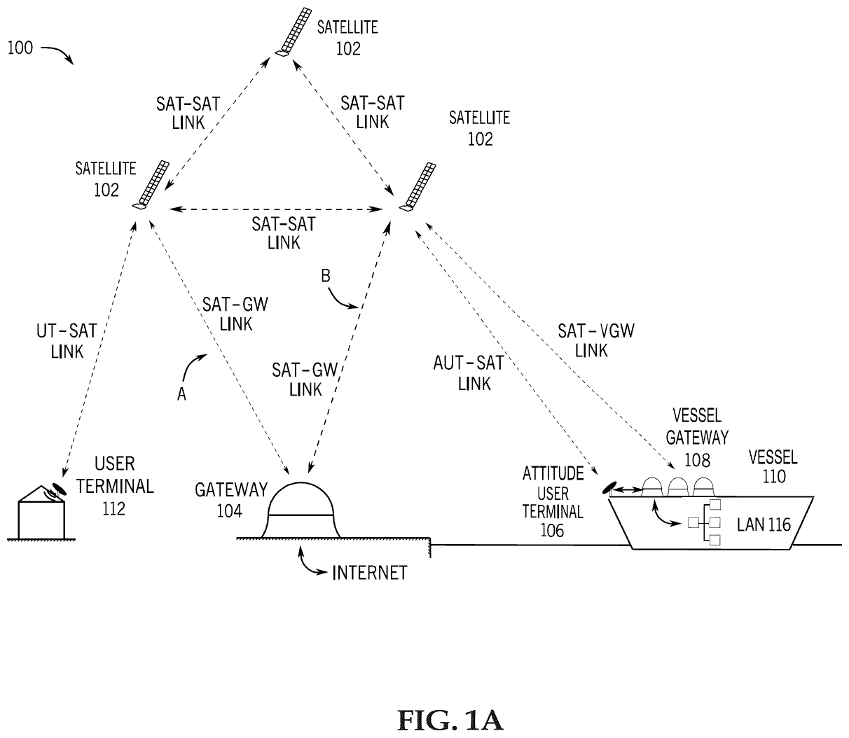

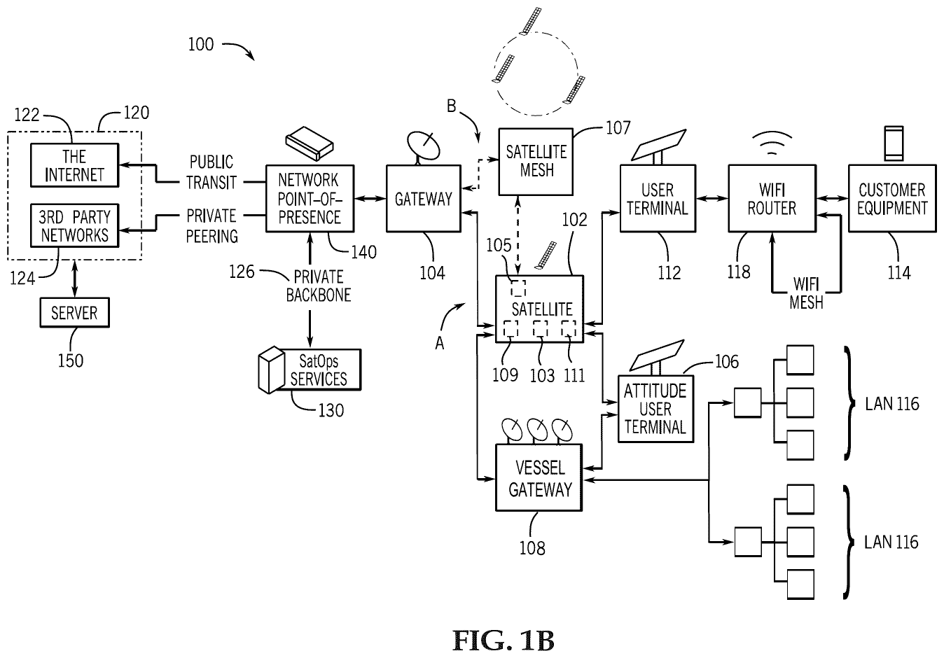

FIG. 1A is a simplified schematic, and FIG. 1B is a simplified block diagram, of elements of an exemplary satellite communication system 100. The elements are capable of communication with each other via a mesh topology. The term “mesh topology” refers to the configuration of the elements as nodes in a mesh network. The various nodes in the mesh network coordinate with one another to efficiently route data in order to respond to requests for user data. As will be discussed in more detail herein, the configuration of the nodes in the mesh topology changes dynamically in satellite communication system 100 to account for factors such as the motion of the satellites 102 relative to the Earth's surface and, in some cases, relative motion among the satellites 102. For example, as part of the network mesh topology of the satellite communication system 100, certain satellites 102 may communicate directly with each other in a satellite mesh topology 107.

In addition to the satellites 102, the satellite communication system 100 also includes a gateway terminal 104 on Earth. The satellite communication system 100 also typically includes a user terminal 112 on Earth, although embodiments without the user terminal 112 are also contemplated. The user terminal 112 and the gateway terminal 104 may be referred to collectively as “ground terminals. ” Each satellite 102 includes an onboard satellite computer system 103 programmed to manage communications with user terminals 112, gateway terminals 104, and other satellites 102, using one or more communication terminals (e.g., RF antennas and/or laser communication terminals) of the satellite. In particular, the satellite computer system 103 routes communications to and from those nodes through the respective satellite 102 as part of the network mesh topology.

User terminal 112 may be installed at a house, a business, a vehicle (e.g., a land-, air-, or sea-based) vehicle, or another Earth-based location where a user desires to obtain communication access or Internet access via the satellites 102. An Earth-based user terminal 112 may be a mobile or non-mobile terminal connected to Earth or as a non-orbiting body positioned near Earth. For example, an Earth-based user terminal 112 may be in Earth's troposphere, such as within about 10 kilometers (about 6.2 miles) of the Earth's surface, and/or within the Earth's stratosphere, such as within about 50 kilometers (about 31 miles) of the Earth's surface, for example on a stationary object, such as a balloon, or a mobile object, such as an automobile or an airplane.

For example, the user may connect one or more network devices 114 such as desktop computers, laptops, mobile devices, Internet of Things (IoT)-enabled devices, and the like (collectively, “customer equipment”) locally to the user's user terminal 112 and obtain access via satellites 102 to the Internet. Although the local connection between the customer equipment and the user terminal is illustrated as a WiFi router 118 (or more broadly a WiFi mesh), other types of wired or wireless local communication are also contemplated.

The gateway terminal 104 serves as a satellite access gateway for the satellite(s) 102 to communicate with one or more ground-based networks 120, such as the Internet 122 or another ground-based network 124. For example, the “other” type of ground-based network 124 may represent a limited access third-party network, such as but not limited to a cloud computing data center. The gateway terminal 104 may be connected to a point-of-presence (PoP) 140 on the ground-based network 120. For example, a dedicated PoP 140 may be assigned to each gateway terminal 104, and may be physically wired to the gateway terminal 104. In some cases, multiple gateway terminals 104 at a same site can be connected to a same PoP 140. Additionally or alternatively, different gateway terminals 104 at a same site can be connected to different PoPs 140. The PoP 140 may access data from the ground-based network 120 (e.g., from one or more servers 150) and provide the data back through the satellite communication system 100 to the user terminal 112 and network device 114.

In the example embodiment, the satellite communication system 100 also includes a vessel gateway 108 configured to provide an alternative to the user terminal 112 for users on board a vessel 110. In the examples presented herein, the vessel 110 is a marine vessel; however, it is also contemplated that the vessel gateway can be hosted on other types of vessels 110. For example, the vessel 110 can use the vessel gateway 108 to provide backhaul for users on one or more local area networks (LANs) 116 implemented on the vessel 110. The vessel gateway 108 can be implemented using hardware and software similar to that used to implement the gateway terminal 104, as will be discussed in more detail herein.

The illustrated communication signal paths in the satellite communication system 100 include a link between the user terminal 112 and one of the satellites 102 in the mesh, which may be referred to as a UT-SAT link. For example, each of the satellites 102 can include a phased array antenna 111 for transmitting and receiving directional radio frequency (RF) signals, and the user terminal 112 can likewise include a phased array antenna (not shown) for transmitting and receiving directional RF signals in the Ku band. In the exemplary embodiment, the UT-SAT link is implemented as a Ku-band RF link, and the phased array antenna 111 is configured for transmitting and receiving RF signals in the Ku band. However, other types of communication links are also contemplated for implementing the UT-SAT link, for example, other bands or other types of links including optical links. Moreover, while only one user terminal 112 and three satellites 102 are illustrated, satellite communication system 100 may include millions of user terminals 112 and many thousands of satellites 102, and different ones of the user terminals 112 and satellites 102 may use different types of communication links to establish the UT-SAT link.

The illustrated communication signal paths in the satellite communication system 100 also include a link between one of the satellites 102 in the mesh and the gateway terminal 104, which may be referred to as a SAT-GW link. For example, each of the satellites 102 can include a gateway-wavelength antenna 109, and the gateway terminal 104 can also include a gateway-wavelength antenna configured to communicate with the satellite's gateway-wavelength antenna 109. In the exemplary embodiment, the SAT-GW link is implemented as a Ka-band or E-band radio frequency (RF) link, and the gateway-wavelength antenna 109 is a parabolic antenna for transmitting and receiving RF signals in the Ka band, the E band and, or both. However, other types of communication links are also contemplated for implementing the SAT-GW link. For example, the satellites 102 may also include laser communication terminals 105, as described below, that can provide a dual function by serving as the gateway-wavelength antenna 109, and the gateway terminal 104 may also include one or more laser communication terminals for communication with the satellites 102 when atmospheric weather conditions are favorable for ground-to-space (and space-to-ground) laser transmission. It should be understood that the gateway terminals 104 can include multiple antennas in any combination of parabolic antennas, laser communication terminals, or other type of communication links. Moreover, while only one gateway terminal 104 and three satellites 102 are illustrated, satellite communication system 100 may include hundreds of gateway terminals 104 and many thousands of satellites 102, and different ones of the gateway terminals 104 and satellites 102 may use different types of communication links to establish the SAT-GW link.

The illustrated communication signal paths in the satellite communication system 100 can further include links between respective pairs of the satellites 102 in the satellite mesh topology 107, which may be referred to as SAT-SAT links. In the exemplary embodiment, the SAT-SAT links are implemented as optical frequency links, or simply “optical” or “laser-based” links. For example, each of the satellites 102 also includes one or more laser communication terminals 105 for transmitting and receiving laser-based (e.g., optical) signals. The laser communication terminals 105 may be dynamically oriented with respect to the satellite 102 on which they are mounted to enable the laser communication terminals of each satellite 102 to track, and maintain the SAT-SAT links with, other satellites 102 in relative motion with respect to the satellite 102. In the exemplary embodiment, each of the satellites 102 includes multiple laser communication terminals 105 that may be independently oriented to enable each satellite to simultaneously maintain SAT-SAT links with multiple other satellites 102. However, other types of communication links are also contemplated for implementing the SAT-SAT links. Moreover, while only three satellites 102 are illustrated, satellite communication system 100 may include many thousands of satellites 102, and different pairs of the satellites 102 may use different types of communication links to establish the respective SAT-SAT link between them. Additionally, one or more of the satellites 102 may not be configured to establish SAT-SAT links with other satellites 102.

In some instances, communications between the user terminal 112 and the ground-based network 120 may be routed through a particular satellite 102 via a UT-SAT link, and through that same satellite directly to and from the gateway terminal 104 via a SAT-GW link, as shown in path A, without being routed through any other satellites 102. In other words, in some instances it is not necessary for the satellite 102 to utilize or maintain SAT-SAT links with other satellites, or even to be capable of establishing SAT-SAT links with other satellites, for the satellite communication system 100 to route communications between the user terminal 112 and the gateway terminal 104. In other instances, communications between the ground-based network 120 and the user terminal 112 having a UT-SAT link with the particular satellite 102 may be routed through a different satellite 102 that has established a SAT-GW link with the gateway terminal 104, as shown in path B, using one or more SAT-SAT links between the satellites 102 in the satellite mesh topology 107.

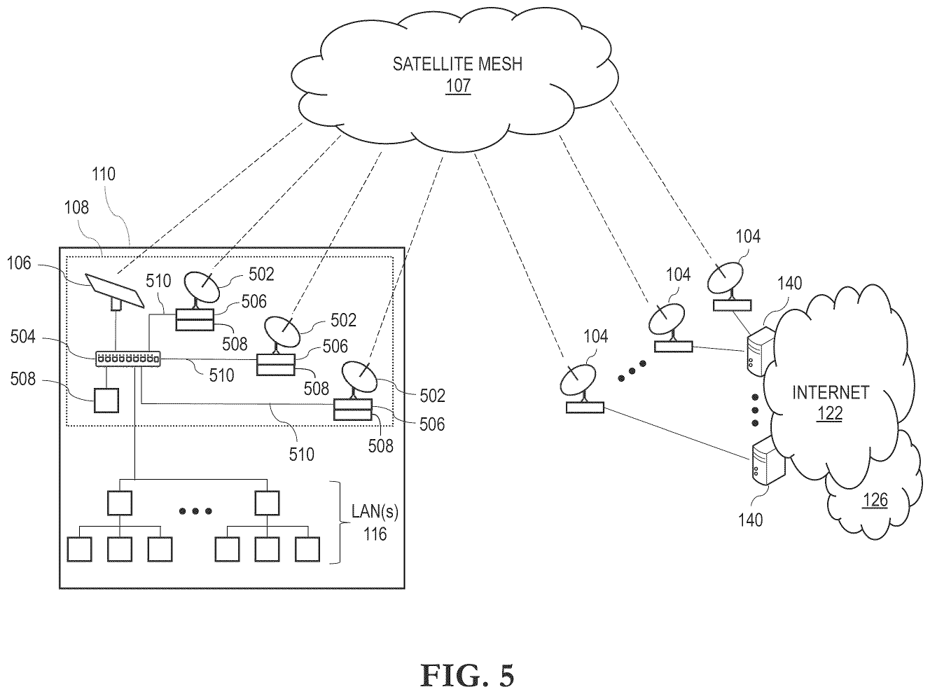

The illustrated communication signal paths in the satellite communication system 100 can further include a link between one of the satellites 102 in the mesh and the vessel gateway 108, which may be referred to as a SAT-VGW link. In the exemplary embodiment, the SAT-VGW link is implemented in the same fashion as the SAT-GW link, for example as a Ka-band or E-band radio frequency (RF) link. In particular, the SAT-VGW link at the satellites 102 can be implemented by the same gateway-wavelength antenna 109 used for making SAT-GW links, and the vessel gateway 108 can also include one or more vessel gateway (VGW) antennas 502 (shown in FIG. 5) for transmitting RF signals to and receiving RF signals from the satellite's gateway-wavelength antenna 109. For example, the VGW antennas 502 can be implemented as parabolic antennas and the RF SAT-VGW links can be implemented in the Ka band, the E band, or both. However, other types of communication links are also contemplated for implementing the SAT-VGW link. For example, the satellites 102 may also include laser communication terminals 105 that can serve a dual function as the gateway-wavelength antenna 109, as described above, and the vessel gateway 108 may also include one or more laser communication terminals for communication with the satellites 102 when atmospheric weather conditions are favorable for ground-to-space (and space-to-ground) laser transmission. It should be understood that the vessel gateway 108 can include multiple antennas in any combination of parabolic antennas, laser communication terminals, or other type of communication links. Moreover, while only one vessel gateway 108 and three satellites 102 are illustrated, the satellite communication system 100 may include thousands of the vessel gateways 108 and many thousands of satellites 102, and different ones of the vessel gateways 108 and satellites 102 may use different types of communication links to establish the SAT-CGW link.

In embodiments in which the same gateway-wavelength antenna 109 of the satellite 102 is used to make both SAT-GW links and SAT-VGW links, one satellite 102 cannot connect simultaneously to one of the vessel gateways 108 and one of the gateway terminals 104. Accordingly, and in contrast to the routing options for the user terminals 112, in such embodiments routing from the vessel gateway 108 to a particular satellite 102, and from the particular satellite directly to one of the gateway terminals 104 to reach the PoP 140, is not available. However, communications between the vessel gateway 108 and the ground-based network 120 can still proceed within acceptable latency thresholds via indirect routing through the satellite mesh topology 107. In other words, requests for user data from the vessel gateway 108 can be routed to a first satellite 102 that has the SAT-VGW link with the vessel gateway 108, from the first satellite through one or more SAT-SAT links between the satellites 102 in the satellite mesh topology 107 to a different satellite 102 that has established a SAT-GW link with the gateway terminal 104, and then via the SAT-GW link to the PoP 140 and on to the ground-based network 120.

In the exemplary embodiment, satellite communication system 100 also includes satellite operations (“SatOps”) services 130 connected to the gateway terminal 104 from a centralized location. In the exemplary embodiment, each gateway terminal 104 is associated with a corresponding PoP 140, and the PoP 140 is connected to the centralized SatOps services 130 via a private backbone 126. The SatOps services 130 may transmit various operational and management instructions to the gateway terminal 104, as well as to the satellites 102 (via the gateway terminal) and to the user terminal 112 and the vessel gateway 108 (via the gateway terminal and the satellites). In the exemplary embodiment, the private backbone 126 may be implemented on an Internet-based secure cloud platform, such as Microsoft Azure® or Amazon Web Services® (AWS) by way of non-limiting examples. However, other implementations of the private backbone 126 are also contemplated.

In some embodiments, the site of the vessel gateway 108 can also include one or more “attitude” user terminals 106 hardwired to the vessel gateway 108 and configured to provide attitude information to a vessel attitude monitoring system, as will be discussed herein. The attitude user terminal 106 can be a version of the user terminal 112 that is adapted to output its current orientation with respect to the Earth to the vessel attitude monitoring system. The vessel attitude monitoring system can use that information to correct the pointing instructions for the parabolic antennas (or alternatively, laser communication terminals) of the vessel gateway 108 to maintain the SAT-VGW link.

Additionally or alternatively, the one or more attitude user terminals 106 can be configured to assist the vessel gateway 108 in making an initial connection to the satellite communication system 100. By way of background, the standard gateway terminals 104 can have a hard-wired connection to one or more of the PoPs 140, and therefore always have a pathway to request an initial connection to the satellite communication system 100 (for example, the request can be sent to a network address associated with the SatOps services 130 via the private backbone 126). As part of the initial connection protocol, the standard gateway terminals 104 can obtain topology schedule data from the SatOps services 130. Using precise, updated ephemeris information specified in the topology schedule data for the satellites that will be in view in the near future, the standard gateway terminals can efficiently establish their scheduled SAT-GW links. Ephemeris information identifies a location of the satellite 102 at a given point (or series of points) in time.

By contrast, the vessel gateway 108 has no hardwired connection to a PoP 140, and thus has no pre-existing pathway to request an initial network connection. Instead, the vessel gateway 108 must somehow be able to establish a pathway through one of the satellites 102 to request an initial connection to the satellite communication system 100, before receiving any current topology schedule data. Absent the precise, updated ephemeris information, a sky search by the parabolic antennas of the vessel gateway 108 itself to find a satellite 102 and establish an initial SAT-VGW link could be relatively inefficient, because the parabolic antennas must be physically slewed to find and track the satellites 102, which limits an efficiency of searching the sky.

On the other hand, the standard user terminals 112 are configured to connect to the satellite communication system 100 by performing a relatively efficient sky search for the satellites 102 using the directional RF beams generated by their phased array antennas. The attitude user terminal 106 can be a version of the user terminal 112 that is further adapted to perform a similar initial sky search on behalf of the vessel gateway 108. In other words, the attitude user terminal 106 can be similar or identical in structure to the standard user terminals 112, and the attitude user terminal 106 can be configured to perform, in association with a start-up, re-boot, or other initialization of the vessel gateway 108, a sky search and acquire an AUT-SAT link, where “AUT” designates that the link involves the attitude user terminal 106 rather than a standard user terminal 112. The attitude user terminal 106 can be configured to use the AUT-SAT link to obtain operational and management information for the vessel gateway 108, such as initial topology schedule data for vessel gateway (VGW) antennas 502 (shown in FIG. 5), from the SatOps services 130 via the private backbone 126, rather than to handle requests for data from end users using the standard UT-SAT link.

For example, to establish an initial connection to the satellite communication system 100, the vessel gateway 108 can execute the same protocol applied by the standard gateway terminals 104, but can route the request through the hardwired connection to the attitude user terminal 106 (instead of through one of the PoPs 140, as done by the standard gateway terminals 104). After the vessel gateway 108 obtains the precise, updated ephemeris information for the satellites 102 via the initial connection protocol through the attitude user terminal 106, the vessel gateway 108 can use the precise, updated ephemeris information to facilitate efficient pointing and slewing of the VGW antennas 502 to establish the high-throughput SAT-VGW link. However, other implementations for requesting an initial connection to the satellite communication system 100 or receiving the initial topology schedule data, including but not limited to performing a sky search for a satellite link using the VGW antennas 502, are also contemplated.

Additionally or alternatively, the one or more attitude user terminals 106 can be used to maintain, via the AUT-SAT link (which can be repeatedly renewed with different satellites as they come into view and then exit in the sky over the vessel 110) and the private backbone 126, an operational connection to the SatOps services 130 that persists after the vessel gateway 108 establishes the initial network connection. In other words, the one or more attitude user terminals sited with the vessel gateway 108 can provide an independent pathway for routing of operational and management information between the SatOps services 130 and the vessel gateway 108, while the SAT-VGW link is simultaneously used exclusively for handling user traffic for users on board the vessel 110. Alternatively, the SAT-CGW link can be used both for routing of operational and management information between the SatOps services 130 and the vessel gateway 108, and for handling traffic for users on board the vessel 110.

### Satellite Constellation

For global coverage having reduced latency, satellite communication system 100 employs non-geostationary satellites, and more specifically low-Earth orbit (LEO) satellites 102. Geostationary-Earth orbit (GEO) satellites orbit the equator with an orbital period of exactly one day at a high altitude, flying approximately 35,786 km above mean sea level. Therefore, GEO satellites remain in the same area of the sky as viewed from a specific location on Earth. In contrast, LEO satellites orbit at a much lower altitude (typically less than about 2,000 km above mean sea level), which reduces Earth-satellite signal travel time and therefore reduces communication latency relative to GEO satellites.

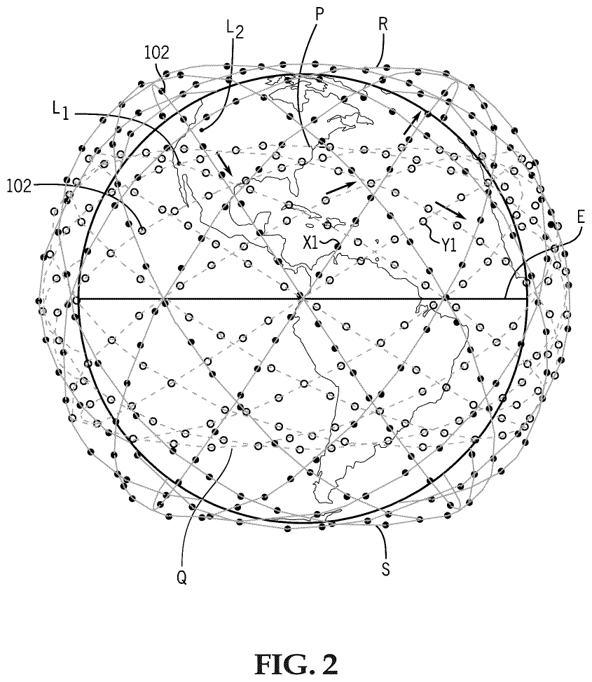

However, a stable low-Earth orbit necessarily corresponds to a much shorter orbital period as compared to GEO satellites. For example, at a particular altitude, a LEO satellite 102 may orbit the Earth, for example, once every 95 minutes. Further in the exemplary embodiment, the low-Earth orbits of satellites 102 are prograde. Therefore, LEO satellites do not remain stationary relative to a specific location on Earth, but rather advance generally eastward with respect to the Earth's surface. In addition, the lower orbital altitude means that, as compared to a GEO satellite, a LEO satellite has a more limited line of sight. For example, a LEO satellite in an equatorial orbit would not have a “line of sight” for direct communication with user terminals or gateway terminals at middle or upper latitudes on Earth, such as at locations L1 (corresponding to Los Angeles, California) and L2 (corresponding to Seattle, Washington) identified in FIG. 2.

Accordingly, satellite communication system 100 may include a large number, for example several thousand, satellites 102 arranged in a constellation of inclined orbits that ensures that at least some satellites 102 are always crossing the sky within range of vessel gateways 108 and user terminals 112 at any given Earth latitude and longitude. One non-limiting embodiment is illustrated in FIG. 2, which is a schematic showing an example of satellite planar orbital patterns X1 and Y1 of satellites 102 around a rotating Earth. In FIG. 2, the satellites in pattern X1 are represented by closed circles, and the satellites in pattern Y1 are represented by open circles, with arrows illustrating a general direction of travel of the satellites in each string. Each satellite string may include a number of equally spaced or substantially equally spaced satellites 102. More specifically, in a frame that rotates with the Earth, satellites 102 in the first string X1 are in discrete orbits sharing a first inclination, and satellites 102 in the second string Y1 are in discrete orbits sharing a second inclination different from the first inclination.

The angle of inclination of the satellites typically corresponds to an upper and lower limiting Earth latitude (indicated as P and Q for satellite string X1, and as R and S for satellite string Y1) of the orbital paths of the satellites. Although two strings at different inclinations are illustrated, other numbers of strings, such as one string or more than two strings, are also contemplated. Moreover, the illustrated angles of inclination are examples, and other angles of inclination for a single string or for multiple strings are also contemplated. Orbital patterns X1 and/or Y1 may be designed as repeating ground track systems, or may have a drifting pattern relative to the Earth's rotation rate.

### Ground Terminal Mesh Topology

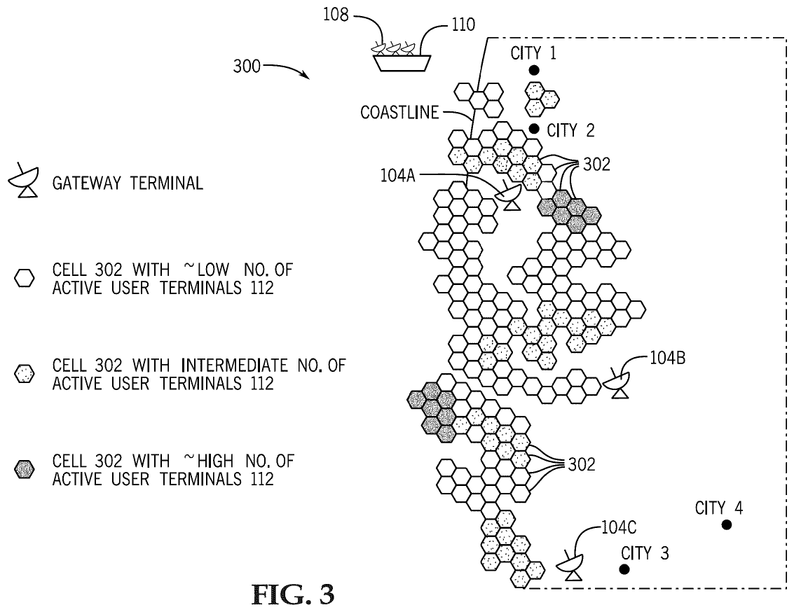

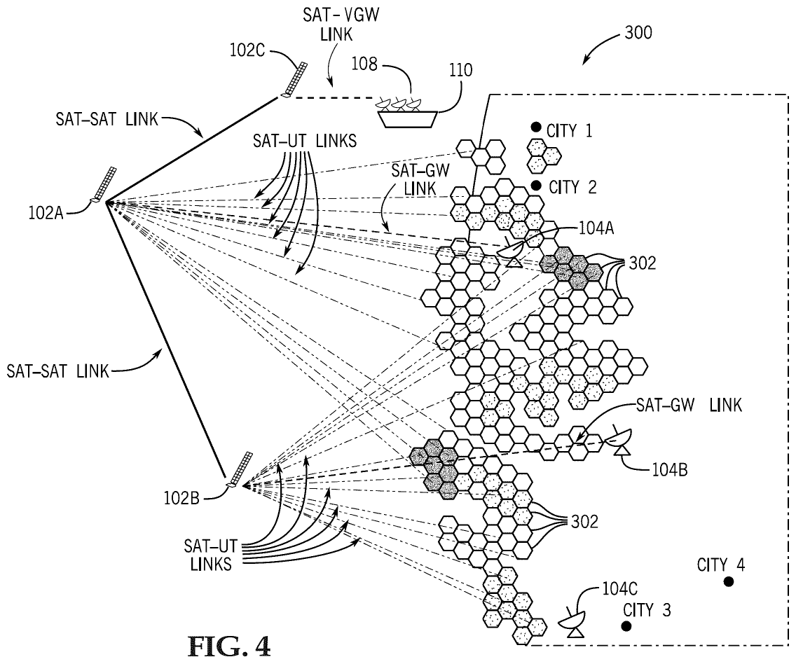

FIG. 3 illustrates a not-to-scale aerial view of an exemplary ground area 300 that may be serviced by the satellite communication system 100. More specifically, the ground area 300 can include a number of user terminals 112 and vessel gateways 108 that may transmit requests for user data to be serviced ultimately by, e.g., server 150 (shown in FIG. 1B) or other data sources. The requests for user data, and the data responsive to the requests, may be routed to and from the user terminals via the network topology of the satellite communication system 100. FIG. 4 illustrates a not-to-scale aerial view of requests from, and responses to, ground area 300 being serviced by example satellites 102A, 102B, and 102C of the group of satellites 102 in communication with example gateway terminals 104A, 104B, and 104C.

The network topology of the satellite communication system 100 may be analogized to a map of roads (travel routes) interconnecting a group of cities (nodes). For road travel between two cities separated by a significant distance, several different road routes may be available, each using roads that connect a different set of intermediate cities. One must know which intermediate cities are connected by roads, and how much traffic there will be on each road, in order to select the best travel route between the two cities.

Similarly, for data travel between two nodes in the satellite communication system 100 (e.g., between a vessel gateway 108 or a user terminal 112 and a data source, such as the ground-based server 150 (shown in FIG. 1B)), several different network routes may be available, each using links that connect a different set of intermediate nodes (i.e., satellites and gateways). One must know which satellites are within the field of view of the user terminal, which satellites and gateways are connected by data links, and how much traffic there will be on each link, in order to select the best data route between the requesting vessel gateway or user terminal and the data source. The topology of the satellite communication system 100 is more complex than a road map, however, because the “roads” (data communication routing through the mesh topology) must be frequently reconfigured to accommodate the relative motion of the satellites 102 with respect to the ground terminals 112, 108, and 104, and in some cases the relative motion of the satellites 102 with respect to each other. In some embodiments, the reconfiguration must occur once or more per minute to accommodate the relative motion of the satellites 102.

In the exemplary embodiment, the ground area 300 includes user terminals 112 grouped into service cells 302 that are geographically fixed relative to the Earth. Although each service cell 302 is illustrated as a hexagonally shaped area, service cells 302 of any shape are contemplated. Moreover, although the service cells 302 are illustrated as having a particular size, other sizes of service cells 302 are contemplated. Service cell size may be a function of multiple factors including, but not limited to, altitude of the satellite constellation, number of satellites in the satellite constellation, number of Earth-based users, geography, etc. The ground area 300 also includes one or more gateway terminals 104.

In some embodiments, the user terminals 112 in each service cell 302 are further grouped into different “lanes” within the service cell 302. The lanes may be, but need not be, associated with particular geographical subregions within the service cell 302. Each combination of a service cell 302 and lane may be associated with a unique network address prefix within the satellite communication system 100, such that all user terminals 112 in a specific service cell and lane can be addressed as a group. For example, if the network addressing scheme is structured similar to Internet Protocol (IP) addressing, each service cell and lane may be associated with a unique network address prefix.

In some embodiments, each user terminal 112 is configured to address requests for user data to a particular PoP 140 (shown in FIG. 1B), which may be referred to as the “home” PoP 140 for the user terminal. The home PoP 140 handles each request for user data by accessing resources on the ground-based network 120 or nodes of the satellite communication system 100 to obtain the requested data, and by accessing the SatOps services 130 to obtain routing instructions for returning the requested data.

In comparison to the user terminals 112, the vessel gateways 108 are each configured to handle a much higher data throughput, as befits servicing one or more LANs 116 on the vessel 110, which may have tens, hundreds, or even thousands of users on board. Each vessel gateway 108 can be assigned a dedicated network address within the satellite communication system 100, rather than being one of many destinations within the network address of one of the service cells 302 as the user terminals 112 are. For example, each vessel gateway 108 can have its own dedicated service cell network address. Other implementations for addressing the user terminals 112 or the vessel gateways 108 are also contemplated.

With reference to FIGS. 1-4, as a result of the motion of satellites 102 relative to the Earth's surface, a particular satellite 102 may be in a position to establish communication with a particular vessel gateway 108, or with the user terminals 112 in a particular service cell 302, for only a limited time window, such as less than ninety minutes, less than sixty minutes, less than thirty minutes, less than fifteen minutes, less than five minutes, or less than one minute. In the exemplary embodiment, the SatOps services 130 assigns, to each vessel gateway 108 and to each service cell 302 (and in some embodiments to each lane within the service cell), one or more of the satellites 102 to be available for linking on a slot-by-slot basis, in which each slot represents a period of time. The period of time, i.e., time slot length, may be selected to accommodate the limited time windows over which any particular satellite may be within the field of view of the vessel gateway 108 or of the user terminals in the service cell. Time slot length may be a function of orbital velocity of the satellite constellation (which in turn may be a function of altitude of the satellite constellation), number of satellites in the satellite constellation, size of the service cells, etc. For example, the time slot length can be between 10 and 120 seconds inclusive. Other time slot lengths are also contemplated.

The SatOps services 130 may transmit topology schedule data to the user terminals 112 in each service cell 302 (e.g., via the gateway terminal 104 and the satellite 102 that are currently providing the physical path for the service cell 302 and lane associated with the respective user terminal 112). The topology schedule data transmitted to the user terminals specifies one or more of the satellites 102 that will be available for connectivity to the respective user terminal 112 during one or more future time slots. The topology schedule data can enable the user terminal (or for the appropriate antenna for other types of UT-SAT links) to determine pointing instructions for the phased array antenna to establish and maintain the corresponding UT-SAT link during the future time slot, as derived from the (known) relative motion of the satellite and the user terminal. In conjunction with the arrival of the future time slot, the user terminal 112 initiates a UT-SAT link with one of the satellites 102 specified by the topology schedule data for that time slot. The topology schedule data can be transmitted to the attitude user terminals 106 in a similar fashion.

Similarly, the SatOps services 130 may transmit topology schedule data to the vessel gateways 108. For example, the topology schedule data can be sent via the gateway terminal 104 and the satellite 102 that are currently in communication with the attitude user terminal 106 of the respective vessel gateway 108 via the AUT-SAT link, and from the attitude user terminal 106 through a hardwired connection to the vessel gateway 108. For another example, the topology schedule data can be sent via the gateway terminal 104 and the satellite 102 that are currently in communication with the respective vessel gateway 108 via the SAT-VGW link. The topology schedule data transmitted to the vessel gateways 108 specifies one or more of the satellites 102 that will be available for connectivity to the respective vessel gateway 108 during one or more future time slots. The topology schedule data can enable the parabolic antennas of the vessel gateway 108 (or for the appropriate antenna for other types of SAT-VGW links) to determine pointing instructions to establish and maintain the corresponding SAT-VGW link during the future time slots, as derived from the (known) relative motion of the satellite and a current reported position of the vessel gateway. In conjunction with the arrival of the future time slot, the parabolic antennas of the vessel gateway 108 initiate a SAT-VGW link with the satellite 102 specified by the topology schedule data for that time slot, with the pointing instructions adjusted for the precise position and orientation of the vessel 110 as necessary based on the vessel attitude monitoring system.

As discussed above with respect to user terminals, a particular satellite 102 also may be in a position to establish communication with a particular gateway terminal 104 for only a limited time window. In the exemplary embodiment, the SatOps services 130 also assigns each satellite 102 to one of the gateway terminals 104 on the slot-by-slot basis. The SatOps services 130 may transmit topology schedule data to the gateway terminals and to the satellites (e.g., via the gateway terminal 104 that is currently in communication with the respective satellite 102). The topology schedule data specifies an expected connectivity between each gateway terminal 104 and one or more satellites 102 during one or more future time slots. The topology schedule data transmitted to each satellite 102 may also enable the satellite computer system 103 to determine pointing instructions for the gateway-wavelength antenna 109 of the satellite (or for the appropriate antenna for other types of SAT-GW links), and likewise the topology schedule data transmitted to each gateway terminal 104 may also enable the gateway terminal 104 to determine pointing instructions for the parabolic antenna of the gateway terminal (or for the appropriate antenna for other types of SAT-GW links), needed to establish and maintain the corresponding SAT-GW link during the future time slots, as derived from the (known) relative motion of the satellite and the gateway terminal. In conjunction with the arrival of the future time slot, the gateway terminal 104 initiates a SAT-GW link with the satellite 102 specified by the topology schedule data for that time slot.

For example, as illustrated in FIG. 4, three satellites 102A, 102B, and 102C are approaching ground area 300 at the start of a particular time slot. The satellites and the vessel gateway 108 have previously received topology schedule data for the particular time slot, specifying satellite 102C for the SAT-VGW link with the vessel gateway 108 during the particular time slot. Accordingly, in conjunction with the arrival of the time slot, the satellite 102C positions its gateway-wavelength antenna 109 and establishes the SAT-VGW link with the vessel gateway 108 to enable communication between the vessel 110 and the satellite communication system 100.

The service cells 302 in the ground area have varying numbers of active user terminals 112. The user terminals 112 in each service cell 302 have previously received topology schedule data for the particular time slot, specifying satellites 102A, 102B, and 102C as being available for UT-SAT links during the particular time slot. Accordingly, in conjunction with the arrival of the time slot, the various user terminals 112 in ground area 300 establish respective links with satellite 102A, 102B, or 102C for communication with satellite communication system 100. Notably, because the satellite 102C uses the phased array antenna 111, rather than the gateway-wavelength antenna 109, for the UT-SAT links, the satellite 102C can maintain both UT-SAT links and the SAT-VGW link during the same time slot. However, in some implementations the satellite 102C is not used for UT-SAT links for the slots in which the SAT-VGW link is scheduled. For example, in some implementations the satellite computer system 103 can service a higher throughput on the SAT-VGW link when no user terminal data requests are being serviced.

As noted previously, because satellite 102C has been instructed to use its gateway-wavelength antenna 109 to establish the SAT-VGW link with the vessel gateway 108 during the time slot, satellite 102C is not instructed to make a SAT-GW link during the time slot. Instead, the satellite computer system of satellite 102C is configured to route data between the vessel gateway 108 and the ground network 120 through the satellite mesh topology 107 to one of the gateway terminals 104. For example, the data can be routed through the SAT-SAT link between satellites 102C and 102A and the SAT-GW link between satellite 102A and gateway terminal 104A. For another example, the data can be routed through the SAT-SAT link between satellites 102C and 102A, the SAT-SAT link between satellites 102A and 102B, and the SAT-GW link between satellite 102B and gateway terminal 104B. Other numbers and locations of gateway terminals 104, satellites 102, and vessel gateways 108, and other implementations of links therebetween, with respect to the ground area 300 are also contemplated.

### Satellite Mesh Topology

The term “satellite mesh topology” refers specifically to the network interconnectivity among the group of satellites 102 as nodes within the overall mesh network, and the configuration of the satellite mesh topology 107 changes dynamically over time in the satellite communication system 100 to account for relative motion among the satellites 102 and other factors.

In the exemplary embodiment, the SatOps services 130 assigns SAT-SAT links among pairs of satellites 102 on the slot-by-slot basis. The SatOps services 130 may include the link assignments in the topology schedule data transmitted to each satellite 102, as discussed above (e.g., via the gateway terminal 104 currently in communication with the respective satellite 102). More specifically, the topology schedule data may specify a connectivity of the respective satellite 102 to other satellites in the satellite mesh topology 107 during the one or more future time slots. The topology schedule data may also enable the satellite computer system 103 to determine pointing instructions for each of the satellite's laser communication terminals 105 (or for the appropriate antenna for other types of SAT-SAT links) needed to establish and maintain the specified SAT-SAT links during the future time slots, as derived from the (known) relative motion of the pair of satellites. In conjunction with the arrival of the future time slot, the satellite computer system 103 dynamically establishes SAT-SAT links with the other satellites specified by the topology schedule data for that time slot, as well as the SAT-GW link with the gateway terminal 104 (or the SAT-VGW link with the vessel gateway 108) specified for that time slot.

### Example Implementation of the Vessel Gateway

FIG. 5 is a simplified block diagram of example elements of the vessel gateway 108 in combination with certain elements of the satellite communication system 100. In the exemplary embodiment, the vessel gateway 108 includes a plurality of vessel gateway (VGW) antennas 502 each configured to communicate with the satellite mesh topology 107 (for example, via the gateway-wavelength antennas 109 of the satellites 102 as shown in FIG. 1B). The vessel gateway 108 also includes a network switch 504 coupled in signal communication between the VGW antennas 502 and the one or more local area networks (LANs) 116 of user devices present on the vessel 110. For example, users on board the vessel 110 can connect their customer equipment 114 to the LANs 116 to obtain Internet connectivity through the satellite communication system 100.

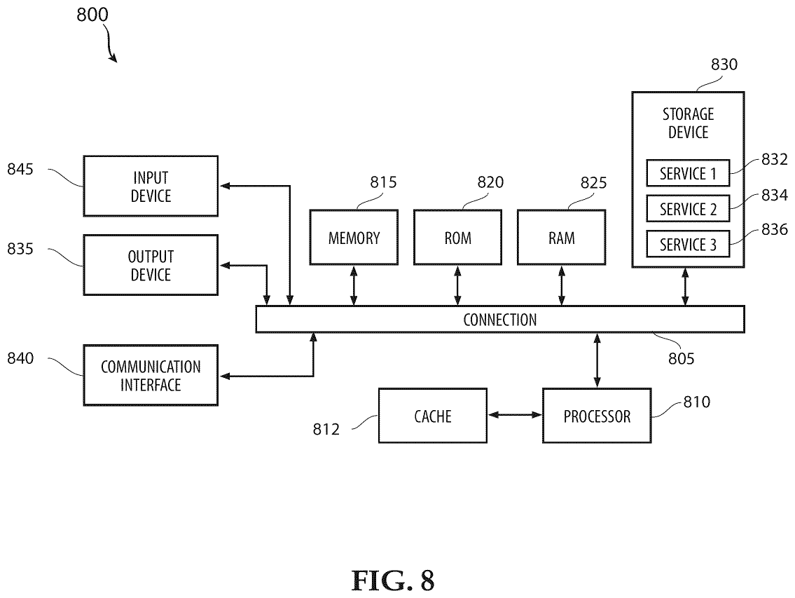

Each VGW antenna 502 includes a network interface processor 506 in signal communication with the network switch 504 via an antenna-switch signal path 510. More specifically, the network switch 504 can include one or more processors (for example, as shown in an example in FIG. 8) configured to manage the switching of data packets between the LANs 116 and the different network interface processors 506 connected to the network switch. Each network interface processor 506 can be configured to receive data packets from the network switch 504 and provide the data packets to the associated VGW antenna 502 for transmission to the satellite mesh topology 107, and to route data packets received from the satellite mesh topology 107 by the associated VGW antenna 502 to the network switch 504. The network interface processors 506 can each include a network interface processor memory storing instructions executable to cause the network interface processor to perform network interface steps. For example, each network interface processor 506 (and associated network interface processor memory) can be implemented as one or more application-specific integrated circuits (ASICs), field-programmable gate arrays (FPGAs), central processing units (CPUs) coupled to random access or read-only memory devices, other suitable types of processors or memories, or any combination thereof. Likewise, the network switch 504 can include a network switch memory storing instructions executable to cause the network switch to perform network switch steps. For example, the one or more processors of the network switch 504 (and associated network switch memory) can be implemented as one or more application-specific integrated circuits (ASICs), field-programmable gate arrays (FPGAs), central processing units (CPUs) coupled to random access or read-only memory devices, other suitable types of processors or memories, or any combination thereof.

As discussed above, the vessel gateway 108 can also include one or more attitude user terminals 106 configured to communicate with the satellite mesh topology 107 (for example, via the phased array antennas 111 of the satellites 102 as shown in FIG. 1B). The vessel gateway 108 can also include one or more control processors 508 configured to enable configuration, monitoring, and control of one or more of: the VGW antennas 502, the network switch 504, the network interface processors 506, the attitude user terminal 106, or other elements of the vessel gateway 108. For example, each of the VGW antennas 502 can include a corresponding one of the control processors 508 configured to monitor and control the VGW antenna 502. Alternatively, a separate control processor 508 can be linked to one or more of the VGW antennas 502 via the network switch 504, for example, to monitor and control the one or more VGW antennas 502. Each control processor 508 can obtain the topology schedule data received via the attitude user terminal 106 from the SatOps services 130 (shown in FIG. 1B). For another example, the control processor 508 can implement the vessel attitude monitoring system. The vessel attitude monitoring system can be configured to receive input from each of the one or more attitude user terminals 106 indicating a real-time position and orientation of the respective attitude user terminal 106 with respect to the Earth, and deduce the current orientation of the vessel 110. In other words, assuming the attitude user terminals 106 are rigidly mounted to the vessel, the orientation of the attitude user terminals 106 can serve as a proxy for the orientation of the vessel 110. The vessel attitude monitoring system can further be configured to adjust the antenna pointing instructions for the SAT-VGW link to compensate for motion and orientation of the vessel 110 relative to the Earth. Using the adjusted pointing instructions, the control processor 508 can command the VGW antenna 502 to make the SAT-VGW links specified for the time slots in the topology schedule data.

Certain other elements of the satellite communication system 100 are illustrated in FIG. 5 with the same reference numbers used in FIGS. 1A and 1B. For example, a plurality of the gateway terminals 104 are illustrated in signal communication between the satellite mesh topology 107 and a plurality of the PoPs 140, which provide access to the Internet 122 (and to the private backbone 126 of the satellite communication system 100). More specifically, end users on the one or more LANs 116 on board the vessel 110 can obtain access to the Internet 122 via the network switch 504, the antenna-switch signal paths 510, the VGW antennas 502, the satellite mesh topology 107, the gateway terminals 104, and the PoPs 140. Similarly, the control processor 508 can obtain access to the private backbone 126 via the network switch 504, the attitude user terminals 106, the satellite mesh topology 107, the gateway terminals 104, and the PoPs 140. Additionally or alternatively, the control processor 508 can obtain access to the private backbone 126 via the VGW antennas 502, the satellite mesh topology 107, the gateway terminals 104, and the PoPs 140.

The vessel gateway 108 is illustrated as including three VGW antennas 502. The use of multiple VGW antennas 502 can significantly reduce a downtime in a connectivity between the network switch 504 and the Internet 122. For example, in some embodiments, each satellite 102 can be in a low Earth orbit moving with a velocity, relative to the surface of the Earth, that causes the satellite to be in view of the VGW antennas 502 during a visibility window that lasts approximately ninety to one hundred fifty seconds. In other words, each VGW antenna 502 loses its connection to the satellite mesh topology 107 approximately every two minutes as the current satellite disappears over the horizon, and must physically slew to point at a different satellite 102 approaching over the opposite horizon in order to establish a new connection to the satellite mesh topology 107. Therefore, an individual VGW antenna 502 can be without a SAT-VGW link (and, thus, without a high-throughput connection to the Internet 122) at regular intervals. Accordingly, the vessel gateway 108 can include two, three, or even four VGW antennas 502 configured to operate such that at least one of the VGW antennas 502 substantially always has an active connection to the satellite mesh topology 107. Other numbers of VGW antennas 502 for the vessel gateway 108 (including a single VGW antenna 502) are also contemplated.

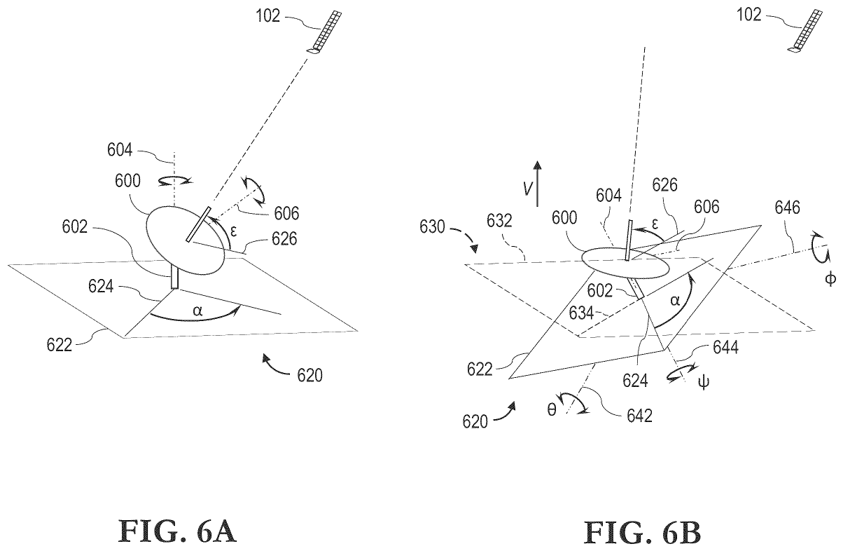

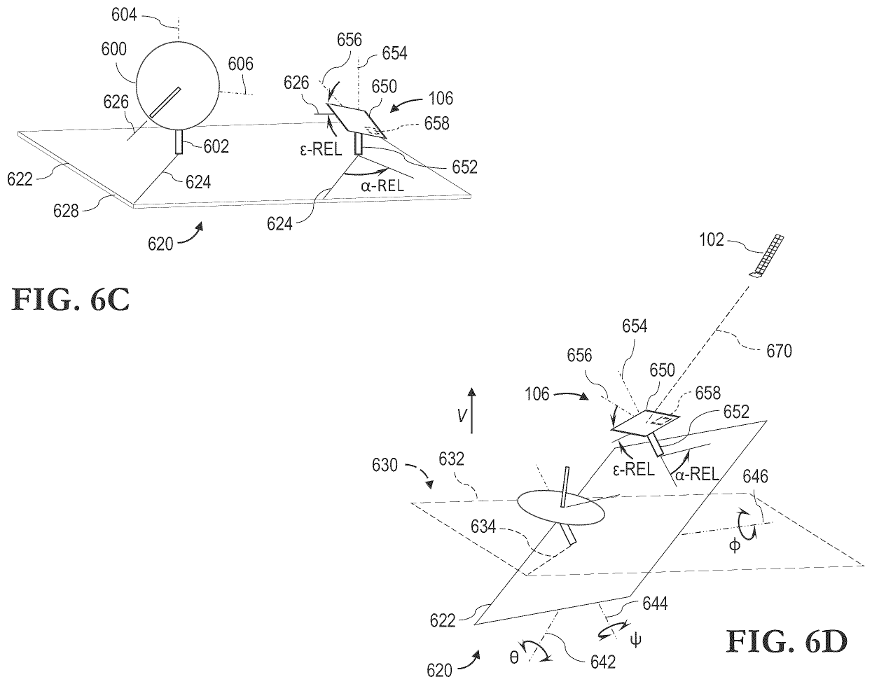

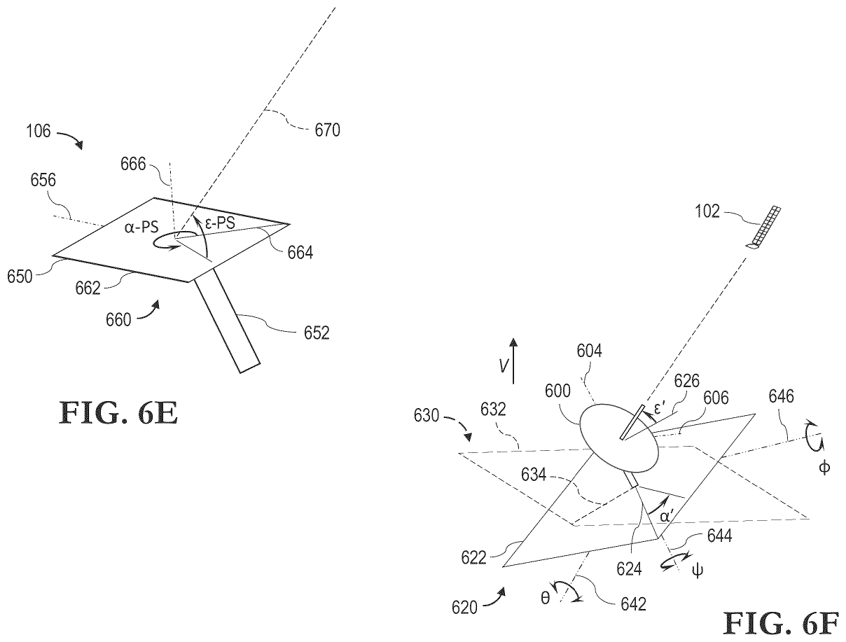

FIG. 6A illustrates a simplified schematic diagram of an example embodiment of a parabolic antenna 600 in an example pedestal-based reference frame 620. For example, the parabolic antenna 600 can be used to implement the gateway terminal 104 or the VGW antenna 502. The parabolic antenna 600 can be mounted on a pedestal 602. The parabolic antenna 600 can be rotated about a pedestal axis 604, and also about a tilt axis 606 that is orthogonal to the pedestal axis 604. The alignment of the tilt axis 606 moves with rotation of the parabolic antenna 600 about the pedestal axis 604.

The pedestal-based reference frame 620 can be defined with respect to the pedestal 602. For example, the pedestal-based reference frame 620 can include a reference plane 622 defined normal to the pedestal 602, a reference direction 624 fixed in the reference plane 622, and a reference elevation 626 (that is, a reference angle) defined about, and fixed with respect to, the tilt axis 606. In the illustrated example, the reference elevation 626 is zero degrees (that is, at the reference angle, the parabolic antenna points in a direction parallel to the reference plane 622). However, other angular values for the reference elevation 626 are contemplated.

The parabolic antenna 600 can be configured to receive and implement pointing instructions in coordinates measured with respect to the pedestal-based reference frame 620. For example, the pointing instructions can include an azimuth rotation α, measured relative to the reference direction 624, about the pedestal axis 604 to a vertical plane in which both the pedestal axis 604 and the satellite 102 lie, and an elevation angle ε within that vertical plane (and about the tilt axis 606), measured relative to the reference elevation 626. The parabolic antenna 600 can include motors (not shown) configured to rotate the parabolic antenna 600 to the specified azimuth rotation α and elevation angle ε. Other coordinates or reference frames for the pointing instructions are also contemplated.

For the parabolic antenna 600 implemented at the gateway terminal 104, the pedestal-based reference frame 620 can be assumed to be fixed with respect to the Earth. For example, the reference plane 622 can be the ground plane at the site of the gateway terminal 104, and the reference direction 624 can be selected as a fixed compass direction (that is, defined in terms of north, south, east, or west), Moreover, the ephemeris of each of the satellites 102 over the upcoming time slots is also known to the satellite communication system 100 and can be provided to the gateway terminal via the private backbone 126 (shown in FIG. 1B). Accordingly, determining the pointing instructions for the parabolic antenna 600 to the satellite 102 based on the satellite's ephemeris in coordinates based on the pedestal-based reference frame 620 is sufficient to enable accurate pointing of the parabolic antenna 600 to the satellite 102 for purposes of the gateway terminal 104.

In contrast, if the parabolic antenna 600 is used to implement the VGW antennas 502, the pedestal-based reference frame 620 cannot be assumed to be fixed with respect to the Earth, due to rotational motion of the vessel 110 to which the VGW antennas 502 are mounted. Accordingly, it is not straightforward to apply the pointing instructions based on a vector from the position of the parabolic antenna to the satellite in an Earth-based reference frame to the pedestal-based reference frame 620 due to the rotational motion of the vessel 110. Instead, a correction or adjustment to the pointing instructions is needed to account for the orientation of the vessel 110.

For example, FIG. 6B illustrates a simplified schematic diagram of an example orientation, relative to an Earth-fixed reference frame 630, of the parabolic antenna 600 mounted on the vessel 110 and applying “uncorrected” pointing instructions developed for the pedestal-based reference frame 620. The VGW antennas 502 can be rigidly mounted to the vessel 110, such that the pedestal-based reference frame 620 can be assumed to move with the vessel 110. For example. the reference plane 622 can be viewed as a deck of the vessel 110, and the pedestal 602 can be mounted on the deck. The Earth-fixed reference frame 630 can include an Earth-fixed plane 632 normal to a vertical direction V and fixed with respect to the Earth. In this context, “vertical” means parallel to the direction of gravity. In other words, the Earth-fixed reference frame 630 is fixed with respect to a compass direction 634 (that is, a direction defined in terms of north, south, east, or west) lying in the Earth-fixed plane 632.

The orientation of the pedestal-based reference frame 620 relative to the Earth-fixed reference frame 630 can be given by a set of frame orientation coordinates 640. For example, the frame orientation coordinates 640 can include a pitch angle θ about a pitch axis 642, a roll angle φ about a roll axis 644, and a yaw angle ψ about a yaw axis 646. The pitch axis 642, roll axis 644, and yaw axis 646 can be mutually orthogonal and fixed in the pedestal-based reference frame 620. Other suitable frame orientation coordinates 640 are also contemplated. As illustrated schematically in FIG. 6B, for non-zero values of any of the frame orientation coordinates 640, the position-based pointing instructions (for example, the azimuth rotation α and the elevation angle ε) for the parabolic antenna 600 to the satellite 102, if applied without correction, will result in inaccurate pointing of the parabolic antenna 600 and an unsuccessful attempt to link to the satellite 102.

Although the examples presented herein are described with respect to the parabolic antenna 600, it should be understood that the approaches to adjusting pointing instructions based on orientation information from the attitude user terminal 106, as described below, are likewise applicable to any type of steerable antenna device mounted on the vessel 110 and used for the SAT-VGW link, such as but not limited to laser communication terminals.

FIG. 6C illustrates a simplified schematic diagram of an example orientation of the attitude user terminal 106 and the parabolic antenna 600 mounted on the vessel 110. With reference also to FIGS. 1A and 5, the attitude user terminal 106 (like the standard user terminals 112) can include a phased array antenna 650 mounted on an AUT pedestal 652, and an embedded AUT processor 658. As will be described in more detail below, the attitude user terminal 106 can be configured to use signals received from the satellites 102 to determine the orientation of the phased array antenna 650 with respect to the Earth-fixed reference frame 630. The vessel attitude monitoring system implemented by the control processor 508 can be programmed to use the orientation of the phased array antenna 650 with respect to the Earth-fixed reference frame 630, in combination with the relative orientation of the phased array antenna 650 and the parabolic antenna 600 in the pedestal-based reference frame 620, to determine the orientation of the parabolic antenna 600 with respect to the Earth-fixed reference frame 630, as will be described below.

With regard to the relative orientation of the phased array antenna 650 and the parabolic antenna 600 with respect to the pedestal-based reference frame 620 (that is, with respect to the vessel 110), it should be understood that, in contrast to the parabolic antenna 600, the phased array antenna 650 does not need to be physically steered or slewed in order to track LEO satellites 102 moving across the sky. Rather, the orientation of the phased array antenna 650 can be fixed with respect to the vessel 110 (and, therefore, fixed with respect to the pedestal-based reference frame 620), and the phased array antenna 650 can use suitable beamforming techniques to adjust transmission and receiving angles for the AUT-SAT link. More specifically, the phased array antenna 650 can include groups of antenna elements (not shown) arranged on a panel and operated in concert to produce (transmit) or detect (receive) high-gain, directional radio frequency beams. The beam can be steered across the sky (without physically moving the phased array antenna 650) by manipulating the phase and amplitude of the transmitted or received signal at the individual antenna elements. Because the phased array antenna 650 does not require physical movement to track the satellites, the orientation of the phased array antenna 650 can be fixed with respect to the vessel 110. For example, the orientation can be selected to direct the phased array antenna 650 to a field of view that suitably encompasses expected flight paths of the satellites 102 while the vessel 110 is in motion, while avoiding obstacles (such as smokestacks or control towers) on the vessel 110 that could obstruct signals from the satellites.

The vessel attitude monitoring system can determine the relative orientation of the phased array antenna 650 and the parabolic antenna 600 (that is, the fixed orientation of the phased array antenna 650 relative to the pedestal-based reference frame 620) as part of a calibration process within the pedestal-based reference frame 620 for the parabolic antenna 600. As shown in FIG. 6C, the position calibration process can include accurately aligning the parabolic antenna 600 to point in the reference direction 624 at the reference elevation 626. For example, as part of the calibration process, outputs from azimuth and elevation feedback sensors (not shown) of the parabolic antenna 600 can be stored by the control processor 508 as a zero reference point for the pointing instructions. Appropriate calibration alignments and sensors for the parabolic antenna 600 configured for steering by a method other than azimuth rotation and elevation angle are also contemplated. For the parabolic antenna 600 implemented at the stationary gateway terminal 104, this can be sufficient to ensure accurate pointing. As discussed above, for the parabolic antenna 600 implemented as the VGW antenna 502 on the vessel 110, additional steps are needed to enable accurate pointing.

More specifically, while the parabolic antenna 600 is aligned for position calibration, the attitude user terminal 106 can be activated and the AUT processor 658 can detect the orientation of the phased array antenna 650 with respect to the Earth-fixed reference frame 630. The control processor 508 can receive an orientation signal from the AUT processor 658 indicating the detected orientation of the phased array antenna 650 in the Earth-fixed reference frame 630, compare the detected orientation of the phased array antenna 650 to the known orientation of the parabolic antenna 600 in the calibration position, and determine the relative orientation of the phased array antenna 650 and the parabolic antenna 600 in the pedestal-based reference frame 620.

For example, the calibration process can be performed while the parabolic antenna 600 and the attitude user terminal 106 are installed on a mounting platform 628 but before the common mounting platform 628 is affixed to the vessel 110. Accordingly, the orientation of the mounting platform 628 (and, thus, the pointing direction of the parabolic antenna 600 in the calibration position) relative to the Earth-fixed reference frame 630 can be known during the calibration process, enabling a direct determination of the relative orientation of the phased array antenna 650 and the parabolic antenna 600.

Other methods for determining and storing the relative orientation of the phased array antenna 650 and the parabolic antenna 600 are also contemplated.

In some embodiments, the relative orientation of the phased array antenna 650 within the pedestal-based reference frame 620 can be determined and stored as a relative azimuth angle α-REL and a relative elevation angle ε-REL. The relative azimuth angle α-REL can be measured from the reference direction 624 about an AUT pedestal axis 654 parallel to the pedestal axis 604, and the relative elevation angle ε-REL can be measured from the reference elevation 626 about an AUT tilt axis 656 that is orthogonal to the AUT pedestal axis 654. In other words, the relative azimuth angle α-REL represents the orientation of the phased array antenna 650 with respect to the reference direction 624 associated with the parabolic antenna 600, and the relative elevation angle ε-REL represents the orientation of the phased array antenna 650 with respect to the reference elevation 626 associated with the parabolic antenna 600.

In embodiments in which the vessel gateway 108 includes multiple VGW antennas 502, the calibration process can be performed for each corresponding parabolic antenna 600, and the control processor 508 associated with each VGW antenna 502 can determine and store separate values for the relative azimuth angle α-REL and the relative elevation angle ε-REL for the attitude user terminal 106 with respect to each of the multiple parabolic antennas 600. The use of other coordinates to describe the relative orientation of the phased array antenna 650 and the parabolic antenna 600 in the pedestal-based reference frame 620 is also contemplated.

FIG. 6D illustrates a simplified schematic diagram of an example orientation, with respect to the Earth-fixed reference frame 630, of the attitude user terminal 106 and the parabolic antenna 600 mounted on the vessel 110, and FIG. 6E illustrates a simplified schematic diagram of an example orientation, with respect to a user terminal (UT)-fixed reference frame 660, of a position signal 670 received at the phased array antenna 650. As noted above, and with reference also to FIGS. 1A, 1B, and 5, the AUT processor 658 of the attitude user terminal 106 can learn the orientation of the phased array antenna 650 with respect to the Earth-fixed reference frame 630 based on the RF position signal 670 transmitted by one or more of the satellites 102. For example, each satellite 102 can be configured to send the position signal 670 on a regular basis via the phased array antenna 111. The AUT processor 658 can be configured to detect the position signal from any one or more satellites currently in view of the phased array antenna 650 by performing a sky search (that is, by rapidly moving an angle of the directional RF receiving beam to cover different regions of the field of view of the phased array antenna 650). An orientation at which the position signal 670 is received from the satellite 102 can be determined from the angle of strongest reception of the position signal 670 at the phased array antenna 650.

The position signal 670 can include network information that enables any user terminals 112 (including, in this case, the attitude user terminal 106) in the footprint of the position signal 670 to initiate the UT-SAT link with that satellite 102. In particular for purposes of orientation, the position signal can include information identifying the ephemeris of the transmitting satellite 102. As noted above, the ephemeris is sufficient to locate the broadcasting satellite in the Earth-fixed reference frame 630 at the time of broadcast of the position signal 670. The AUT processor 658 can be configured to determine the location of the attitude user terminal 106 relative to the Earth-fixed reference frame 630, for example from an integrated Global Positioning System (GPS) receiver or another suitable source. The AUT processor 658 can then learn the orientation of the phased array antenna 650 with respect to the Earth-fixed reference frame 630 by comparing the orientation of receipt of the position signal 670 against the satellite ephemeris included in the position signal. Notably, the AUT processor 658 can base the orientation determination on the position signal 670 from one or more others of the satellites 102 over the vessel 110 in addition, or alternatively, to the position signal 670 transmitted by the satellite 102 which the parabolic antenna 600 is tracking.

The UT-fixed reference frame 660 can be defined with respect to the phased array antenna 650. For example, the UT-fixed reference frame 660 can include a reference plane 662 defined by the phased array antenna 650 (for example, a plane on which the individual antenna elements of the phased array antenna 650 are arranged), a reference direction 664 fixed in the reference plane 662, and a normal direction 666 defined normal to the reference plane 662. In some embodiments, the coordinates used to describe the orientation of receipt of the position signal 670 can include a position signal azimuth rotation α-PS, measured relative to the reference direction 664, about the normal direction 666 to a signal plane in which the normal direction 666 and the position signal 670 lie, and a position signal elevation angle ε-PS within the signal plane measured relative to the reference plane 662. Other coordinates for describing the orientation of receipt of the position signal 670 relative to the UT-fixed reference frame 660 are also contemplated.

The AUT processor 658 can determine a vector, in the Earth-fixed reference frame 630, from the transmit location of the satellite 102 (which can be derived from the ephemeris information included in the position signal 670) to the position of the attitude user terminal 106 (known, for example, from GPS or otherwise as discussed above). The AUT processor 658 can then determine an angle of incidence of the vector on the reference plane 662 of the phased array antenna 650 (as defined for example by the position signal azimuth rotation α-PS and the position signal elevation angle ε-PS), and determine the corresponding orientation of the reference plane 662 with respect to the Earth-fixed reference frame 630. For example, the orientation of the reference plane 662 with respect to the Earth-fixed reference frame 630 can be expressed in coordinates relative to the compass direction 634 and the vertical direction V (or in coordinates relative to other defining references of the Earth-fixed reference frame 630).

This orientation determination capability can be a standard feature of the user terminals 112. For example, the user terminals 112 need to know the orientation of their respective phased array antennas in order to use the ephemeris information in the position signal 670 accurately to track the satellite 102 across the sky for further communication of user data. In some embodiments, the vessel gateway 108 can leverage this standard orientation-determination capability of user terminals 112, inherently present in the attitude user terminal 106, to determine the orientation of the VGW antennas 502 as well. Embodiments are also contemplated in which the orientation-determination capability of the attitude user terminal 106 is not standard to user terminals 112 of the satellite communication system 100, or in which another device or method including a phased array antenna is used by the vessel gateway 108 to determine the orientation of the parabolic antenna 600 mounted on the vessel 110 with respect to the Earth-fixed reference frame 630.

The AUT processor 658 can be configured to output to the vessel attitude monitoring system executing on the control processor 508, for example via the switch 504, orientation signals indicating the detected orientation of the phased array antenna 650 with respect to the Earth-fixed reference frame 630 at a regular time interval in real-time. For example, the regular time interval can be on the order of ten to one hundred milliseconds, in order to enable the vessel attitude monitoring system to adjust for the effect of waves on a marine vessel sufficiently quickly to maintain accurate pointing of the parabolic antenna 600. Other time intervals are also contemplated.

The AUT processor 658 can also be configured to indicate the position of the attitude user terminal 106 in the Earth-fixed reference frame 630 (known, for example, from GPS as noted above) in the orientation signals, for example to enable the control processor 508 to determine the pointing instructions to the satellite 102 based on the real-time position of the vessel 110 as it travels. Alternatively, the control processor 508 can detect the current position of the vessel 110 in real time from another suitable source.

Using the orientation signal received from the attitude user terminal 106, the vessel attitude monitoring system can determine the orientation of the pedestal-based reference frame 620 relative to the Earth-fixed reference frame 630 based on the fixed (and known) orientation of the phased array antenna 650 relative to the pedestal-based reference frame 620. For example, the vessel attitude monitoring system can apply the relative azimuth angle α-REL and the relative elevation angle ε-REL learned during the calibration process to convert the orientation of the phased array antenna 650 relative to the Earth-fixed reference frame 630 into the orientation of the pedestal-based reference frame 620 relative to the Earth-fixed reference frame 630.

More specifically, as described above, the relative azimuth angle α-REL represents the orientation of the phased array antenna 650 with respect to the reference direction 624 in the pedestal-based reference frame 620, and the relative elevation angle ε-REL represents the orientation of the phased array antenna 650 with respect to the reference elevation 626 in the pedestal-based reference frame 620. Accordingly, these values enable the reference direction 624 and the reference elevation 626 to be located within the Earth-fixed reference frame 630. For example, the orientation of the reference direction 624 and the reference elevation 626 (or other defining references of the pedestal-based reference frame 620) relative to the compass direction 634 and the vertical direction V (or other defining references of the Earth-fixed reference frame 630) can be expressed in terms of the frame orientation coordinates 640. As the vessel attitude monitoring system receives the real-time orientation signals from the attitude user terminal 106 at the regular time interval, the vessel attitude monitoring system can determine the corresponding orientation of the pedestal-based reference frame 620 relative to the Earth-fixed reference frame 630 in real-time repeatedly at the same regular time interval (or at another suitable time interval).

FIG. 6F illustrates a simplified schematic diagram of the parabolic antenna 600 mounted on the vessel 110 and applying adjusted pointing instructions. More specifically, with reference also to FIG. 5, the control processor 508 can use the real-time values of the frame orientation coordinates 640 generated by the vessel attitude monitoring system to adjust the pointing instructions from the current location of the vessel 110 to the satellite 102. For example, the control processor 508 can determine a vector, in the Earth-fixed reference frame 630, from the current location of the vessel 110 to the satellite's current location as derived from the ephemeris information for the satellite 102. That vector can correspond to the “unadjusted” pointing instructions (for example, the azimuth rotation α and the elevation angle ε shown in FIG. 6A) that would apply if the parabolic antenna 600 were fixed in the Earth-fixed reference frame 630. As noted above, the control processor 508 can receive the ephemeris information in the topology schedule data sent in advance from the SatOps services 130 and routed through either the attitude user terminal 106 (forwarded through the network switch 504) or through the VGW antenna 502.

The control processor 508 can also generate adjusted pointing instructions repeatedly at the regular time interval (or at another suitable time interval) to point the parabolic antenna 600 along the vector based on the real-time values of the frame orientation coordinates 640 generated by the vessel attitude monitoring system. For example, the control processor 508 can generate an adjusted azimuth rotation α′ and an adjusted elevation angle ε′ that can be used to command the parabolic antenna 600, in its native pedestal-based reference frame 620, to accurately point at the satellite 102 despite the pedestal-based reference frame 620 being rotated relative to the Earth-fixed reference frame 630. The control processor 508 can further command the parabolic antenna 600 to apply the adjusted pointing instructions. For example, the control processor 508 can cause the motors (not shown) that drive the parabolic antenna 600 to apply the adjusted azimuth rotation α′ and elevation angle ε′ in the pedestal-based reference frame 620, relative to the reference direction 624 and the reference elevation 626 respectively, to accurately point at the satellite 102.

For example, the control processor 508 can determine projections of the pitch angle θ, the roll angle φ, and the yaw angle ψ on the reference plane 622, and can subtract those projections from the unadjusted azimuth rotation α to obtain the adjusted azimuth rotation α′. For another example, the control processor 508 can determine projections of the pitch angle θ, the roll angle φ, and the yaw angle ψ on a plane normal to the tilt axis 606, and can subtract those projections from the unadjusted elevation angle ε to obtain the adjusted elevation angle ε′. Other implementations for using the frame orientation coordinates 640 to determine the adjusted azimuth rotation α′ and the adjusted elevation angle ε′ are also contemplated.

In some embodiments, the vessel gateway 108 can include one or more additional attitude user terminals 106. In other words, the vessel gateway can include multiple attitude user terminals, such as two, three, or another suitable number of attitude user terminals 106. For example, the orientation of the phased array antenna 650 as determined by the attitude user terminal 106 can be subject to an uncertainty range, caused for example by signal noise or other factors. The uncertainty range can be insignificant for standard user terminals 112, but in some circumstances may become significant when the orientation is used to adjust the pointing instructions in real time for the VGW antenna 502 of the vessel gateway 108. The control processor 508 can use the orientation signals received from the multiple attitude user terminals 106 to advantageously reduce or eliminate the effect of the uncertainty range on the adjusted pointing instructions.

For example, during the calibration process for the parabolic antenna 600, the control processor 508 for each of the VGW antennas 502 can determine and store separate values for the relative azimuth angle α-REL and the relative elevation angle ε-REL corresponding to each of the multiple attitude user terminals 106. These values also indicate a relative orientation of the phased array antennas 650 of the multiple attitude user terminals 106 to each other, which should remain constant since the phased array antennas 650 are rigidly affixed to the vessel 110. During operation of the parabolic antenna 600, the control processor 508 can be configured to determine the adjusted pointing instructions at each time based on a blend of the real-time orientation signals received from the multiple attitude user terminals 106. For example, the blend can give weight to the orientations that best fit the calibration-determined relative orientation of the phased array antennas 650 of the multiple attitude user terminals 106 to each other. Other implementations for combining or blending the orientation signals received from the multiple attitude user terminals 106 are also contemplated.

Additionally or alternatively, the use of the multiple attitude user terminals 106 can advantageously improve fault tolerance for the vessel gateway 108. For example, if one or more of the multiple attitude user terminals 106 requires maintenance or experiences a temporary difficulty in establishing an AUT-SAT link, the control processor 508 can rely on the orientation signals received from another of the multiple attitude user terminals 106.

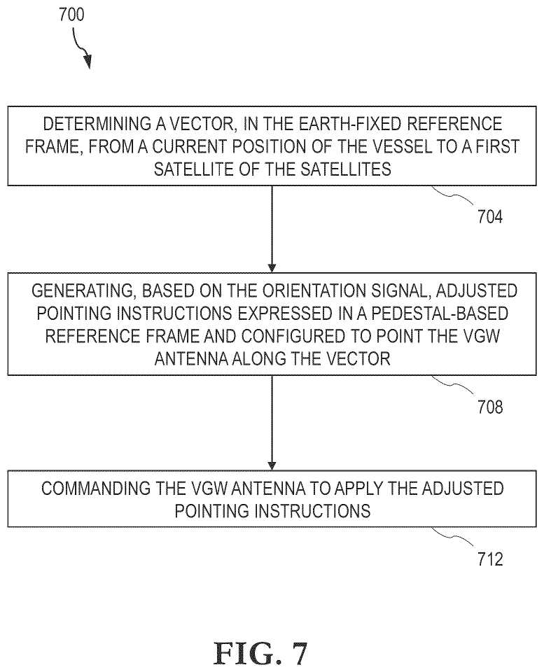

FIG. 7 illustrates an example method 700 of operating a vessel gateway for a satellite communication system, wherein the satellite communication system includes a plurality of satellites, wherein the vessel gateway includes a pedestal affixed to a vessel; a vessel gateway (VGW) antenna mounted on the pedestal and steerable to track any one of the satellites according to pointing instructions expressed relative to a pedestal-based reference frame; an attitude user terminal (AUT) including an AUT phased array antenna affixed to the vessel and configured to output an orientation signal indicating an orientation of the AUT phased array antenna with respect to an Earth-fixed reference frame; and a control processor coupled in signal communication with the attitude user terminal and configured to perform steps of the method 700, which can include one or more of: determining a vector, in the Earth-fixed reference frame, from a current position of the vessel to a first satellite of the satellites (704); generating, based on the orientation signal, adjusted pointing instructions expressed in the pedestal-based reference frame and configured to point the VGW antenna along the vector (708); and commanding the VGW antenna to apply the adjusted pointing instructions (712).

A system embodiment can include a vessel gateway for a satellite communication system including a plurality of satellites. The vessel gateway can include a pedestal affixed to a vessel; a vessel gateway (VGW) antenna mounted on the pedestal and steerable to track any one of the satellites according to pointing instructions expressed relative to a pedestal-based reference frame; an attitude user terminal (AUT) including an AUT phased array antenna affixed to the vessel and configured to output an orientation signal indicating an orientation of the AUT phased array antenna with respect to an Earth-fixed reference frame; and a control processor coupled in signal communication with the attitude user terminal and coupled to a memory storing instructions executable to cause the control processor to perform control processor steps of the method 700, which can include one or more of: determining a vector, in the Earth-fixed reference frame, from a current position of the vessel to a first satellite of the satellites; generating, based on the orientation signal, adjusted pointing instructions expressed in the pedestal-based reference frame and configured to point the VGW antenna along the vector; and commanding the VGW antenna to apply the adjusted pointing instructions.

In some embodiments, each of the satellites further includes a satellite (SAT) phased array antenna, and the AUT phased array antenna is configured to communicate with the SAT phased array antenna via an AUT-SAT link.

In certain embodiments, each of the satellites includes a satellite (SAT) gateway-wavelength antenna, and the VGW antenna is configured to communicate with the SAT gateway-wavelength antenna via a SAT-VGW link.

In some embodiments, the attitude user terminal includes an AUT processor coupled to a memory storing instructions executable to cause the AUT processor to perform AUT steps including: causing the AUT phased array antenna to perform a sky search to acquire the AUT-SAT link; and obtaining, via the AUT-SAT link, topology schedule data specifying the first satellite for tracking by the VGW antenna.

In certain embodiments, the satellite communication system further includes a terrestrial satellite operations (SatOps) services platform, and the AUT steps further include maintaining an operational connection to the SatOps services platform via the AUT-SAT link.

In some embodiments, the attitude user terminal includes an AUT processor coupled to a memory storing instructions executable to cause the AUT processor to perform AUT steps including determining the orientation of the AUT phased array antenna with respect to the Earth-fixed reference frame based on a position signal transmitted by a second satellite of the satellites.

In certain embodiments, the second satellite is the first satellite.

In some embodiments, the AUT step of determining the orientation of the AUT phased array antenna includes determining a position of the second satellite in the Earth-fixed reference frame based on ephemeris information for the second satellite included in the position signal.

In certain embodiments, the AUT step of determining the orientation of the AUT phased array antenna further includes determining a vector from a position of the attitude user terminal to the position of the second satellite.

In some embodiments, the AUT step of determining the orientation of the AUT phased array antenna further includes: determining an angle of incidence of the vector on the AUT phased array antenna; and determining the orientation of the AUT phased array antenna with respect to the Earth-fixed reference frame based on the angle of incidence.

In certain embodiments, the control processor step of generating the adjusted pointing instructions includes determining an orientation of the pedestal-based reference frame relative to the Earth-fixed reference frame based on the orientation signal.

In some embodiments, the control processor step of determining the orientation of the pedestal-based reference frame relative to the Earth-fixed reference frame includes applying a fixed orientation of the phased array antenna relative to the pedestal-based reference frame to locate a defining reference of the pedestal-based reference frame within the Earth-fixed reference frame.

In certain embodiments, the control processor steps further include, during a calibration process for the VGW antenna, determining the fixed orientation of the AUT phased array antenna relative to the pedestal-based reference frame.

In some embodiments, the control processor step of determining the fixed orientation of the AUT phased array antenna relative to the pedestal-based reference frame includes: while the VGW antenna is pointing in a reference direction at a reference elevation during the calibration process, receiving one or more additional orientation signals from the attitude user terminal, wherein the one or more additional orientation signals each indicate a further orientation of the AUT phased array antenna with respect to the Earth-fixed reference frame, and wherein the reference direction and the reference elevation are fixed within the pedestal-based reference frame; and determining, based on the one or more additional orientation signals, the fixed orientation of the phased array antenna relative to the reference direction and the reference elevation.

In certain embodiments, the attitude user terminal is configured to output the orientation signal at a regular time interval in real-time, and the control processor step of generating the adjusted pointing instructions based on the orientation signal is repeated at the regular time interval or another regular time interval in real-time.

In some embodiments, the satellite communication system further includes a plurality of terrestrial gateway terminals in communication with the plurality of satellites, the terrestrial gateway terminals are in communication with the Internet, and the VGW antenna is configured to provide Internet connectivity through the satellites and the gateway terminals for users on one or more local area networks (LANs) implemented on the vessel.

In certain embodiments, the attitude user terminal is one of multiple attitude user terminals affixed to the vessel, and the control processor step of generating the adjusted pointing instructions includes blending the orientation signal received from each of the multiple attitude user terminals.

Additional or alternative steps in light of the disclosure herein are also contemplated.

FIG. 8 illustrates an example computer device that can be used in connection with any of the systems or components of the control processor 508, the AUT processor 658, the SatOps services 130, the network switch 504, the network interface processor 506, the gateway terminal 104, the PoP 140, the satellite computer system 103, the user terminal 112, the ground-based server 150, or other components disclosed herein. In this example, FIG. 8 illustrates a computing system 800 including components in electrical communication with each other using a connection 805, such as a bus. System 800 includes a processing unit (CPU or processor) 810 and a system connection 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware or software service, such as service 1—832, service 2—834, and service 3—836 stored in storage device 830, configured to control the processor 810 as well as a special-purpose processor where software instructions are incorporated into the actual processor design. The processor 810 may be a completely self-contained computing system, containing multiple cores or processors, a bus, memory controller, cache, etc. A multi-core processor may be symmetric or asymmetric.

To enable user interaction with the device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include services 832, 834, 836 for controlling the processor 810. Other hardware or software modules are contemplated. The storage device 830 can be connected to the system connection 805. In one aspect, a hardware module that performs a particular function can include the software component stored in a computer-readable medium in connection with the necessary hardware components, such as the processor 810, connection 805, output device 835, and so forth, to carry out the function.

In some embodiments, computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A vessel gateway for a satellite communication system including a plurality of satellites, the vessel gateway comprising:
a pedestal affixed to a vessel;
a vessel gateway (VGW) antenna mounted on the pedestal and steerable to track any one of the satellites according to pointing instructions expressed relative to a pedestal-based reference frame;
an attitude user terminal (AUT) including an AUT phased array antenna affixed to the vessel, wherein the attitude user terminal is configured to output an orientation signal indicating an orientation of the AUT phased array antenna with respect to an Earth-fixed reference frame; and
a control processor coupled in signal communication with the attitude user terminal and coupled to a memory storing instructions executable to cause the control processor to perform control processor steps including:
determining a vector, in the Earth-fixed reference frame, from a current position of the vessel to a first satellite of the satellites;
generating, based on the orientation signal, adjusted pointing instructions expressed in the pedestal-based reference frame and configured to point the VGW antenna along the vector; and
commanding the VGW antenna to apply the adjusted pointing instructions.

2. The vessel gateway according to claim 1, wherein each of the satellites further includes a satellite (SAT) phased array antenna, and wherein the AUT phased array antenna is configured to communicate with the SAT phased array antenna via an AUT-SAT link.

3. The vessel gateway according to claim 2, wherein each of the satellites includes a satellite (SAT) gateway-wavelength antenna, wherein the VGW antenna is configured to communicate with the SAT gateway-wavelength antenna via a SAT-VGW link.

4. The vessel gateway according to claim 2, wherein the attitude user terminal includes an AUT processor coupled to a memory storing instructions executable to cause the AUT processor to perform AUT steps including:
causing the AUT phased array antenna to perform a sky search to acquire the AUT-SAT link; and
obtaining, via the AUT-SAT link, topology schedule data specifying the first satellite for tracking by the VGW antenna.

5. The vessel gateway according to claim 4, wherein the satellite communication system further includes a terrestrial satellite operations (SatOps) services platform, and wherein the AUT steps further include maintaining an operational connection to the SatOps services platform via the AUT-SAT link.

6. The vessel gateway according to claim 1, wherein the attitude user terminal includes an AUT processor coupled to a memory storing instructions executable to cause the AUT processor to perform AUT steps including determining the orientation of the AUT phased array antenna with respect to the Earth-fixed reference frame based on a position signal transmitted by a second satellite of the satellites.

7. The vessel gateway according to claim 6, wherein the second satellite is the first satellite.

8. The vessel gateway according to claim 6, wherein the AUT step of determining the orientation of the AUT phased array antenna includes determining a position of the second satellite in the Earth-fixed reference frame based on ephemeris information for the second satellite included in the position signal.

9. The vessel gateway according to claim 8, wherein the AUT step of determining the orientation of the AUT phased array antenna further includes determining a vector from a position of the attitude user terminal to the position of the second satellite.

10. The vessel gateway according to claim 9, wherein the AUT step of determining the orientation of the AUT phased array antenna further includes:
determining an angle of incidence of the vector on the AUT phased array antenna; and
determining the orientation of the AUT phased array antenna with respect to the Earth-fixed reference frame based on the angle of incidence.

11. The vessel gateway according to claim 1, wherein the control processor step of generating the adjusted pointing instructions includes determining an orientation of the pedestal-based reference frame relative to the Earth-fixed reference frame based on the orientation signal.

12. The vessel gateway according to claim 11, wherein the control processor step of determining the orientation of the pedestal-based reference frame relative to the Earth-fixed reference frame includes applying a fixed orientation of the phased array antenna relative to the pedestal-based reference frame to locate a defining reference of the pedestal-based reference frame within the Earth-fixed reference frame.

13. The vessel gateway according to claim 12, wherein the control processor steps further include, during a calibration process for the VGW antenna, determining the fixed orientation of the AUT phased array antenna relative to the pedestal-based reference frame.

14. The vessel gateway according to claim 13, wherein the control processor step of determining the fixed orientation of the AUT phased array antenna relative to the pedestal-based reference frame includes:
while the VGW antenna is pointing in a reference direction at a reference elevation during the calibration process, receiving one or more additional orientation signals from the attitude user terminal, wherein the one or more additional orientation signals each indicate a further orientation of the AUT phased array antenna with respect to the Earth-fixed reference frame, and wherein the reference direction and the reference elevation are fixed within the pedestal-based reference frame; and
determining, based on the one or more additional orientation signals, the fixed orientation of the phased array antenna relative to the reference direction and the reference elevation.

15. The vessel gateway according to claim 1, wherein the attitude user terminal is configured to output the orientation signal at a regular time interval in real-time, and wherein the control processor step of generating the adjusted pointing instructions based on the orientation signal is repeated at the regular time interval or another regular time interval in real-time.

16. The vessel gateway according to claim 1, wherein the satellite communication system further includes a plurality of terrestrial gateway terminals in communication with the plurality of satellites, wherein the terrestrial gateway terminals are in communication with the Internet, and wherein the VGW antenna is configured to provide Internet connectivity through the satellites and the gateway terminals for users on one or more local area networks (LANs) implemented on the vessel.

17. The vessel gateway according to claim 1, wherein the attitude user terminal is one of multiple attitude user terminals affixed to the vessel, and wherein the control processor step of generating the adjusted pointing instructions includes blending the orientation signal received from each of the multiple attitude user terminals.

18. A method of operating a vessel gateway for a satellite communication system, wherein the satellite communication system includes a plurality of satellites, wherein the vessel gateway includes a pedestal affixed to a vessel, a vessel gateway (VGW) antenna mounted on the pedestal and steerable to track any one of the satellites according to pointing instructions expressed relative to a pedestal-based reference frame, an attitude user terminal (AUT) including an AUT phased array antenna affixed to the vessel and configured to output an orientation signal indicating an orientation of the AUT phased array antenna with respect to an Earth-fixed reference frame, and a control processor coupled in signal communication with the attitude user terminal and configured to perform steps of the method including:
determining a vector, in the Earth-fixed reference frame, from a current position of the vessel to a first satellite of the satellites;
generating, based on the orientation signal, adjusted pointing instructions expressed in the pedestal-based reference frame and configured to point the VGW antenna along the vector; and
commanding the VGW antenna to apply the adjusted pointing instructions.

19. The method according to claim 18, wherein each of the satellites further includes a satellite (SAT) phased array antenna, and wherein the AUT phased array antenna is configured to communicate with the SAT phased array antenna via an AUT-SAT link.

20. The method according to claim 19, wherein each of the satellites includes a satellite (SAT) gateway-wavelength antenna, wherein the VGW antenna is configured to communicate with the SAT gateway-wavelength antenna via a SAT-VGW link.

21-34. (canceled)
